(19) United States
(12) Patent Application Publication
(10) Pub. No.: US 2023/0086980 A1
(43) Pub. Date: Mar. 23, 2023

(54) METHOD FOR GENERATING A DATA SET FOR TRAINING AND/OR TESTING A MACHINE LEARNING ALGORITHM ON THE BASIS OF AN ENSEMBLE OF DATA FILTERS

(71) Applicant: Robert Bosch GmbH, Stuttgart (DE)

(72) Inventors: Lydia Gauerhof, Sindelfingen (DE); Andreas Albrecht, Esslingen (DE); Moritz Hoersch, Stuttgart (DE)

(21) Appl. No.: 17/940,851

(22) Filed: Sep. 8, 2022

(30) Foreign Application Priority Data
Sep. 17, 2021 (DE) 10 2021 210 322.7

(51) Int. Cl. G06N 20/20

(52) U.S. Cl. CPC G06N 20/20

(57) ABSTRACT

A method for generating a data set for training and/or testing a machine learning algorithm. The method includes: providing a first data set, wherein the first data set comprises data potentially relevant to the machine learning algorithm, providing an ensemble of data filters, configuring each data filter of the ensemble of data filters on the basis of requirements of the machine learning algorithm, and selecting the first data set by filtering the first data set by means of at least a part of the configured data filters of the ensemble of data filters in order to obtain data for training and/or testing the machine learning algorithm, wherein the data form the data set for training and/or testing the machine learning algorithm.

### CROSS REFERENCE

The present application claims the benefit under 35 U.S.C. § 119 of German Patent Application No. DE 10 2021 210 322.7 filed on Sep. 17, 2021, which is expressly incorporated herein by reference in its entirety.

### BACKGROUND INFORMATION

The present invention relates to a method for generating a data set for training and/or testing a machine learning algorithm on the basis of an ensemble of data filters, with which method a data set for training and/or testing a machine learning algorithm can be generated on the basis of which the properties of a machine learning algorithm can be improved and storage capacities required for storing the training data set or testing data set can simultaneously be reduced. Moreover, the present invention relates to a method for verifying a machine learning algorithm trained to solve a particular problem, on the basis of an ensemble of further machine learning algorithms trained to solve the same problem.

Machine learning algorithms are based on statistical methods being used to train a data processing system in such a way that it can perform a particular task without it being originally programmed explicitly for this purpose. The goal of machine learning is to construct algorithms that can learn and make predictions from data. These algorithms create mathematical models with which data can be classified, for example.

Such machine learning algorithms are used, for example, for processing information from highly automated or autonomous systems, for example autonomously driving motor vehicles. In this case, a model, for example an artificial neural network, is trained on the basis of a cost function with the aid of an optimization method on a predetermined training data set against a ground truth reference. For each data element in the training data set, there is a ground truth reference, which describes the properties to be learned of the machine learning algorithm for the corresponding data element.

However, it has been found to be disadvantageous here that information or properties to be learned that are not included in the predetermined training data set are not trained, which can lead, for example, to safety-critical situations when controlling autonomously driving motor vehicles on the basis of the corresponding machine learning algorithm. If it was furthermore attempted to include all information, this would lead to a large data set and consequently to a high storage requirement for storing the training data set. Also, when testing a trained machine learning algorithm, only the features that are also contained in a testing data set are checked. Consequently, there is a need for a targeted selection of data for training and/or testing a machine learning algorithm.

A method for training a number of neural networks is described in European Patent Application No. EP 1 623 371 A2, wherein a first training data set is determined, wherein the training data have a particular accuracy, a number of second training data sets is generated by adding noise to the first training data set with a random variable, and each of the neural networks is trained with one of the training data sets.

### SUMMARY

An object of the present invention is to provide an improved method for generating a data set for training and/or testing a machine learning algorithm.

The object may be achieved by a method for generating a data set for training and/or testing a machine learning algorithm according to the features of present invention.

Furthermore, the object may also be achieved by a control device for generating a data set for training and/or testing a machine learning algorithm according to the present invention.

Advantageous embodiments and developments emerge from the disclosure herein.

According to one example embodiment of the present invention, this object is achieved by a method for generating a data set for training and/or testing a machine learning algorithm, wherein a first data set is provided, wherein the first data set comprises data potentially relevant to the machine learning algorithm, wherein an ensemble of data filters is provided, wherein each data filter of the ensemble of data filters is configured on the basis of requirements of the machine learning algorithm, and wherein the first data set is selected by filtering the first data set by means of at least a part of the configured data filters of the ensemble of data filters in order to obtain data for training and/or testing the machine learning algorithm, wherein the data form the data set for training and/or testing the machine learning algorithm.

The expression “data potentially relevant to the machine learning algorithm” is understood here to mean data which generally characterize content or information that can be learned by the machine learning algorithm.

With a data filter, data can furthermore be filtered or sorted on the basis of corresponding parameters. For example, the data filters can be designed to filter out, from the elements or data of the first data set, the data that comprise particular objects, in particular if the machine learning algorithm is an object or image classification algorithm.

The expression “an ensemble of data filters” is understood here to mean a combination of two or more data filters. Here, the expression “the first data set is filtered by means of at least a part of the data filters of the ensemble of data filters” means that the first data set is filtered by means of at least one data filter of the ensemble of data filters, but the first data set is preferably filtered by at least two data filters of the ensemble of data filters.

The expression “requirements or data requirement of the machine learning algorithm” is understood here to mean requirements imposed on the training data, i.e., which information they should comprise in order to optimize the properties of the machine learning algorithm, or information about a property yet to be learned which should be contained or depicted in the training data. The requirements of the machine learning algorithm can be oriented to the question as to what the algorithm should be able to do or still learn. For example, the data filters can be configured in such a way that data representing scenarios not yet trained are in particular selected as data for training the machine learning algorithm.

According to an example embodiment of the present invention, a method is provided in which, by means of a particular configuration of the data filters, desired or required data can be filtered out of the entirety of the first data set and can be used as training data for training the machine learning algorithm or as testing data for testing the machine learning algorithm. Consequently, a targeted selection of data for training and/or testing the machine learning algorithm can be made, whereby all possible or relevant scenarios are in particular covered in the training and/or testing of the machine learning algorithm and, for example, the properties of the machine learning algorithm trained on the basis of the data can also be optimized. This in turn has the advantage that, for example, safety-critical situations when controlling functions of an autonomously driving motor vehicle can subsequently be avoided by the trained machine learning algorithm. At the same time, the amount of data required for the complete or optimal training and/or testing of the machine learning algorithm can be reduced, which results in comparatively low storage capacities required for storing the data set for training and/or testing the machine learning algorithm so that the machine learning algorithm can also be trained and/or tested completely on control devices with low storage and computing capacities, for example control devices integrated in an autonomously driving motor vehicle. Overall, an improved method for generating a data set for training and/or testing a machine learning algorithm is thus provided.

In one example embodiment of the present invention, the step of selecting the first data set by filtering the first data set by means of at least a part of the configured data filters of the ensemble of data filters further comprises filtering the first data set by means of respectively at least a part of the configured data filters of the ensemble of data filters in order to obtain filtered data, wherein the filtered data are subsequently classified on the basis of the requirements of the machine learning algorithm in order to obtain classified data, and wherein training data are selected from the classified data on the basis of the requirements of the machine learning algorithm, wherein the selected training data form a training data set for training the machine learning algorithm. As a result, reliable further processing of the outputs of the filters can be ensured and the efficiency of the method for generating a training data set for training the machine learning algorithm can be further increased. In particular, an additional check as to whether a data element actually corresponds to the requirements or search criteria is incorporated.

Moreover, according to an example embodiment of the present invention, the step of selecting the first data set by filtering the first data set by means of respectively at least a part of the configured data filters of the ensemble of data filters can further also comprise fusing, i.e., joining or merging, the filtered data of various data filters of the ensemble of data filters in order to obtain fused filtered data, wherein the step of classifying the filtered data on the basis of the requirements of the machine learning algorithm can accordingly comprise classifying the fused filtered data on the basis of the requirements of the machine learning algorithm.

The individual data filters can, for example, respectively filter out data that show particular objects, wherein the individual data filters can filter out the same objects as other data filters and/or different objects than other data filters. As a result, both simple data filters and classifications of very complex scenarios which are composed of a plurality of different objects can be taken into account. Overall, this thus provides a flexible, modular and arbitrarily configurable mechanism for data selection.

The data potentially relevant to the machine learning algorithm may furthermore be sensor data.

A sensor, which is also referred to as a detector, (measurement or measuring) transducer or (measuring) probe, is a technical part that can qualitatively detect particular physical or chemical properties and/or the material characteristics of its surroundings or detect them quantitatively as a measured variable. The corresponding sensor may, for example, be an optical sensor.

Circumstances characterizing particular scenarios or information outside of the actual data processing system, on which the machine learning algorithm is trained and/or tested, can thus be detected in a simple manner and taken into account in the training and/or testing of the machine learning algorithm. Furthermore, however, data characterizing particular scenarios or information, which are obtained in a different manner, may also be detected and taken into account in the training and/or testing of the machine learning algorithm.

Moreover, the first data set may additionally comprise metadata.

The term “metadata” or “metainformation” is understood to mean structured data which contain information about attributes of other data. The metadata may in turn be circumstances outside the data processing system on which the machine learning algorithm is trained and/or tested, for example GPS data or IMU data.

Furthermore, the metadata may also be particular labels or identifiers or tags.

By taking into account such metadata, individual scenarios can thus be detected even better or more precisely and the data set for training and/or testing the machine learning algorithm can be optimized even further. Moreover, the richness of the generated data set can be increased.

With a further example embodiment of the present invention, a method for training a machine learning algorithm is also provided, wherein a data set is generated by a method described above for generating a data set for training and/or testing a machine learning algorithm, and the corresponding machine learning algorithm is subsequently trained on the basis of the generated data set.

A method for training a machine learning algorithm on the basis of a training data set generated by an improved method for generating training data for training the machine learning algorithm is thus provided. In particular, according to an example embodiment of the present invention, the training data set is generated by a method in which, by means of a particular configuration of the data filters, desired or required data can be filtered out of the entirety of the first data set and can be used as training data for training the machine learning algorithm. Consequently, a targeted selection of data for training the machine learning algorithm can be made, whereby all possible or relevant scenarios are in particular covered in the training of the machine learning algorithm and, for example, the properties of the machine learning algorithm trained on the basis of the data can also be optimized.

This in turn has the advantage that, for example, safety-critical situations when controlling functions of an autonomously driving motor vehicle can subsequently be avoided by the trained machine learning algorithm. At the same time, the amount of data required for the complete or optimal training of the machine learning algorithm can be reduced, which results in comparatively low storage capacities required for storing the data set for training the machine learning algorithm so that the machine learning algorithm can also be trained completely on control devices with low storage and computing capacities, for example control devices integrated in an autonomously driving motor vehicle.

With a further example embodiment of the present invention, a method for classifying image data is also provided, wherein image data are classified using a machine learning algorithm, and wherein the machine learning algorithm can be trained using a method described above for training a machine learning algorithm.

In particular, the method can be used to classify image data, in particular digital image data, on the basis of low-level features, for example edges or pixel attributes. In this case, an image processing algorithm can furthermore be used to analyze a classification result which is focused on corresponding low-level features.

According to an example embodiment of the present invention, a method for classifying image data that results in a machine learning algorithm trained on an improved training data set is provided. In particular, the training data set was generated by a method in which, by means of a particular configuration of the data filters, desired or required data can be filtered out of the entirety of the first data set and can be used as training data for training the machine learning algorithm. Consequently, a targeted selection of data for training the machine learning algorithm can be made, whereby all possible or relevant scenarios are in particular covered in the training of the machine learning algorithm and, for example, the properties of the machine learning algorithm trained on the basis of the data can also be optimized.

This in turn has the advantage that, for example, safety-critical situations when controlling functions of an autonomously driving motor vehicle can subsequently be avoided by the trained machine learning algorithm. At the same time, the amount of data required for the complete or optimal training of the machine learning algorithm can be reduced, which results in comparatively low storage capacities required for storing the data set for training the machine learning algorithm so that the machine learning algorithm can also be trained completely on control devices with low storage and computing capacities, for example control devices integrated in an autonomously driving motor vehicle.

Moreover, with a further embodiment of the present invention, a method for verifying a machine learning algorithm trained to solve a particular problem is provided, wherein a machine learning algorithm trained to solve the particular problem is provided, and an ensemble of further machine learning algorithms likewise trained to solve the particular problem is moreover provided, wherein first output data are provided by processing provided input data by means of the machine learning algorithm and further output data are moreover provided by likewise processing the provided input data by means of at least a part of the machine learning algorithms of the ensemble of further machine learning algorithms, and wherein the machine learning algorithm is subsequently verified by comparing the first output data with the further output data.

The expression “the machine learning algorithm is trained to solve a particular problem” in this case means that the machine learning algorithm is trained for a particular purpose.

The expression “an ensemble of further machine learning algorithms” is in turn understood to mean a combination of two or more further machine learning algorithms.

The expression “further output data are generated by means of at least a part of the machine learning algorithms of the ensemble of further machine learning algorithms” in turn means that further output data are generated by means of at least one machine learning algorithm of the ensemble of further machine learning algorithms, but further output data are preferably generated by at least two machine learning algorithms of the ensemble of further machine learning algorithms.

The expression “verifying the machine learning algorithm” furthermore means proof that the machine learning algorithm is working properly, i.e., is verified against specific requirements, or testing of the performance, correctness, robustness and/or generalization capability of the machine learning algorithm.

Overall, a method for verifying a machine learning algorithm trained to solve a particular problem is thus provided with which the performance, correctness, robustness and/or generalization capability of a machine learning algorithm trained to solve a particular problem can be tested or verified in a simple manner and with comparatively low computing capacities on the basis of an ensemble of further machine learning algorithms. Testing the performance and/or correctness of the machine learning algorithm also has the advantage that, after corresponding verification of the performance and/or correctness, for example safety-critical situations when controlling functions of an autonomously driving motor vehicle can be avoided by the trained machine learning algorithm.

The machine learning algorithm may, for example, have been trained on the basis of a data set generated by a method described above for generating a data set for training and/or testing a machine learning algorithm.

Moreover, the ensemble of further machine learning algorithms can be combined or merged with the above-described ensemble of data filters, i.e., the ensemble of data filters can be supplemented, for example, by the further machine learning algorithms.

Furthermore, the machine learning algorithm and the machine learning algorithms of the ensemble of further machine learning algorithms may each have been trained on the basis of the same training data. Furthermore, however, it is also possible for the individual machine learning algorithms to be trained at least in part on the basis of different training data.

Furthermore, according to an example embodiment of the present invention, the step of verifying the machine learning algorithm can comprise determining the consistency of the first output data and of the further output data, especially since the consistency of the output data is an important indicator for the performance of the machine learning algorithm, in particular if the further machine learning algorithms or the machine learning algorithms of the ensemble of further machine learning algorithms are better in essential areas, for example with regard to training progress, than the machine learning algorithm itself. For example, the machine learning algorithm and the further machine learning algorithms may each be object recognition algorithms, wherein a check takes place as to whether a consistency in the object recognition is given.

Moreover, according to an example embodiment of the present invention, at least one machine learning algorithm of the ensemble of further machine learning algorithms can be designed to perform a different task than other machine learning algorithms of the ensemble of further machine learning algorithms. For example, a machine learning algorithm of the ensemble of further machine learning algorithms can in turn be designed to identify different objects in the input data than other machine learning algorithms of the ensemble of further machine learning algorithms. As a result, multiple properties in the output data can be evaluated simultaneously and in mutual relation to one another.

At least one machine learning algorithm of the ensemble of further machine learning algorithms can also have a different architecture than other machine learning algorithms of the ensemble of further machine learning algorithms.

The term “architecture” is understood here to mean the appearance or the structure of the machine learning algorithm. In neural networks, the architecture can, for example, comprise the number of layers in the network and the number and/or the types of the neurons in the individual layers.

In this way, further machine learning algorithms can be provided which each have different strengths and weaknesses, and these can be taken into account when verifying the machine learning algorithm.

With a further example embodiment of the present invention, a control device for generating a data set for training and/or testing a machine learning algorithm is also provided, wherein the control device is designed to carry out a method described above for generating a data set for training and/or testing a machine learning algorithm.

A control device designed to carry out an improved method for generating a data set for training and/or testing a machine learning algorithm is thus provided. The control device is in particular designed to carry out a method in which, by means of a particular configuration of the data filters, desired or required data can be filtered out of the entirety of the first data set and can be used as training data for training the machine learning algorithm or as testing data for testing the machine learning algorithm.

Consequently, a targeted selection of data for training and/or testing the machine learning algorithm can be made, whereby all possible or relevant scenarios are in particular covered in the training and/or testing of the machine learning algorithm and, for example, the properties of the machine learning algorithm trained on the basis of the data can also be optimized.

This in turn has the advantage that, for example, safety-critical situations when controlling functions of an autonomously driving motor vehicle can subsequently be avoided by the trained machine learning algorithm. At the same time, the amount of data required for the complete or optimal training and/or testing of the machine learning algorithm can be reduced, which results in comparatively low storage capacities required for storing the data set for training and/or testing the machine learning algorithm so that the machine learning algorithm can also be trained and/or tested completely on control devices with low storage and computing capacities, for example control devices integrated in an autonomously driving motor vehicle.

With a further example embodiment of the present invention, a control device for training a machine learning algorithm is furthermore also provided, wherein the control device is designed to train the machine learning algorithm on the basis of a data set generated by a control device described above for generating a data set for training and/or testing a machine learning algorithm.

A control device designed to train a machine learning algorithm on the basis of a training data set generated by an improved method for generating training data for training the machine learning algorithm is thus provided, according to an example embodiment of the present invention. In particular, the training data set is generated by a method in which, by means of a particular configuration of the data filters, desired or required data can be filtered out of the entirety of the first data set and can be used as training data for training the machine learning algorithm.

Consequently, a targeted selection of data for training the machine learning algorithm can be made, whereby all possible or relevant scenarios are in particular covered in the training of the machine learning algorithm and, for example, the properties of the machine learning algorithm trained on the basis of the data can also be optimized.

This in turn has the advantage that, for example, safety-critical situations when controlling functions of an autonomously driving motor vehicle can subsequently be avoided by the trained machine learning algorithm. At the same time, the amount of data required for the complete or optimal training of the machine learning algorithm can be reduced, which results in comparatively low storage capacities required for storing the data set for training the machine learning algorithm so that the machine learning algorithm can also be trained completely on control devices with low storage and computing capacities, for example control devices integrated in an autonomously driving motor vehicle.

With a further example embodiment of the present invention, a control device for classifying image data is moreover also provided, wherein the control device is designed to classify image data using a machine learning algorithm, and wherein the machine learning algorithm was trained using a control device described above for training a machine learning algorithm.

In particular, the control device can in turn be used to classify image data, in particular digital image data, on the basis of low-level features, for example edges or pixel attributes. In this case, an image processing algorithm can furthermore be used to analyze a classification result which is focused on corresponding low-level features.

A control device for classifying image data that can be used to select data for improved training and/or improved testing of the machine learning algorithm is thus provided, according to an example embodiment of the present invention. The training data set or testing data set is in particular generated by a method in which, by means of a particular configuration of the data filters, desired or required data can be filtered out of the entirety of the first data set and can be used as training data for training the machine learning algorithm and/or as testing data for testing the machine learning algorithm. Consequently, a targeted selection of data for training and/or testing the machine learning algorithm can be made, whereby all possible or relevant scenarios are in particular covered in the training of the machine learning algorithm and, for example, the properties of the machine learning algorithm trained and/or tested on the basis of the data can also be optimized and/or checked. This in turn has the advantage that, for example, safety-critical situations when controlling functions of an autonomously driving motor vehicle can subsequently be avoided by the trained machine learning algorithm. At the same time, the amount of data required for the complete or optimal training or testing of the machine learning algorithm can be reduced, which results in comparatively low storage capacities required for storing the data set for training and/or testing the machine learning algorithm so that the machine learning algorithm can also be trained completely on control devices with low storage and computing capacities, for example control devices integrated in an autonomously driving motor vehicle.

With a further embodiment of the present invention, a control device for verifying a machine learning algorithm trained to solve a particular problem is furthermore also provided, wherein the control device is designed to carry out a method described above for verifying a machine learning algorithm trained to solve a particular problem.

A control device for verifying a machine learning algorithm trained to solve a particular problem is thus provided according to an example embodiment of the present invention, with which the performance of a machine learning algorithm trained to solve a particular problem can be tested or verified in a simple manner and with comparatively low computing capacities on the basis of an ensemble of further machine learning algorithms. Testing the performance of the machine learning algorithm also has the advantage that, after corresponding verification of the performance, for example safety-critical situations when controlling functions of an autonomously driving motor vehicle can be avoided by the trained machine learning algorithm.

The present invention provides a method for generating a data set for training and/or testing a machine learning algorithm on the basis of an ensemble of data filters, with which method a data set for training and/or testing a machine learning algorithm can be generated on the basis of which the properties of a machine learning algorithm can be improved and storage capacities required for storing the training data set or testing data set can simultaneously be reduced.

The described embodiments and developments can be combined with one another as desired.

Other possible embodiments, developments and implementations of the present invention also include not explicitly mentioned combinations of features of the present invention described above or below with respect to the exemplary embodiments.

### BRIEF DESCRIPTION OF THE DRAWINGS

The figures are intended to provide a further understanding of example embodiments of the present invention. They illustrate embodiments and, in connection with the description, are used to explain principles and concepts of the present invention.

Other embodiments and many of the mentioned advantages become apparent from the figures. The illustrated elements of the figures are not necessarily shown to scale with respect to one another.

FIG. 1 is a flow chart of a method for generating a data set for training and/or testing a machine learning algorithm according to example embodiments of the present invention.

FIG. 2 is flow chart of a method for verifying a machine learning algorithm trained to solve a particular problem, according to example embodiments of the present invention.

FIG. 3 is a block diagram of a system for training a machine learning algorithm according to example embodiments of the present invention.

In the figures of the drawings, identical reference signs denote identical or functionally identical elements, parts or components, unless stated otherwise.

### DETAILED DESCRIPTION OF EXAMPLE EMBODIMENTS

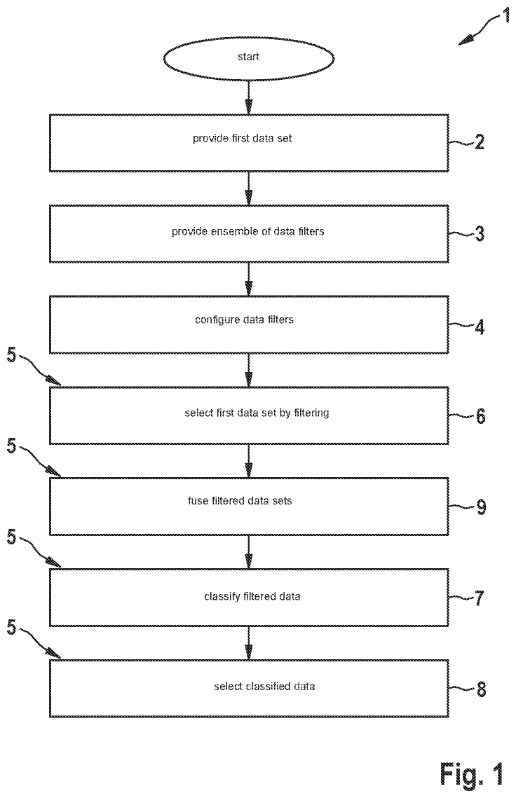

FIG. 1 is a flowchart of a method 1 for generating a data set for training and/or testing a machine learning algorithm according to embodiments of the present invention.

Machine learning algorithms are increasingly being used for processing information of highly automated or autonomous systems, for example autonomously driving motor vehicles. In this case, a model, for example an artificial neural network, is trained on the basis of a cost function with the aid of an optimization method on a particular training data set against a ground truth reference. For each element in the training data set, there is a ground truth reference which shows the property to be learned for the corresponding data element. Subsequently, the model or the machine learning algorithm can moreover be tested, i.e., validated or verified, on the basis of a different data set that has not been used for training the machine learning algorithm.

The model provides an adaptive structure with a particular learning capacity and a particular learning capability. However, the model itself does not contain any learning content or learning information and can therefore be applied in the same way to any similar problems. In this case, the information that the model can learn during training originates exclusively from the training data set. However, this means that information or data content that is not included in the corresponding training data set is also not learned by the model. The situation is similar when testing models or machine learning algorithms at the conclusion of the training phase, whereby only the information or features that also are contained in a corresponding testing data set can be verified or tested.

Consequently, there is a need for a targeted selection of data, such as training data for training a machine learning algorithm or testing data for testing a machine learning algorithm.

FIG. 1 shows a method 1 for generating a data set for training and/or testing a machine learning algorithm, wherein a first data set is provided in a step 2, wherein the first data set comprises data potentially relevant to the machine learning algorithm, wherein an ensemble of data filters is provided in a step 3, wherein each data filter of the ensemble of data filters is configured on the basis of requirements of the machine learning algorithm in a step 4, and wherein the first data set is selected in a step 5 by filtering the first data set by means of at least a part of the configured data filters of the ensemble of data filters in order to obtain data for training and/or testing the machine learning algorithm, wherein the data form the data set for training and/or testing the machine learning algorithm.

A method 1 is thus provided in which, by means of a particular configuration of the data filters, desired or required data can be filtered out of the entirety of the first data set and can be used as training data for training the machine learning algorithm or as testing data for testing the machine learning algorithm. Consequently, a targeted selection of data for training and/or testing the machine learning algorithm can be made, whereby all possible or relevant scenarios are in particular covered in the training and/or testing of the machine learning algorithm and, for example, the properties of the machine learning algorithm trained on the basis of the data can also be optimized. This in turn has the advantage that, for example, safety-critical situations when controlling functions of an autonomously driving motor vehicle can subsequently be avoided by the trained machine learning algorithm. At the same time, the amount of data required for the complete or optimal training and/or testing of the machine learning algorithm can be reduced, which results in comparatively low storage capacities required for storing the data set for training and/or testing the machine learning algorithm so that the machine learning algorithm can also be trained and/or tested completely on control devices with low storage and computing capacities, for example control devices integrated in an autonomously driving motor vehicle. Overall, an improved method 1 for generating a data set for training and/or testing a machine learning algorithm is thus provided.

The provision of the first data set in step 2 can comprise applying a shadowing method, wherein during the operation of a device, for example of a motor vehicle, a target function also runs in the background in shadow mode without actively engaging in operating or driving functions. In this case, data can be permanently acquired and the acquired data can be stored when particular conditions occur, for example if differences between an actual behavior of a driver of the motor vehicle and the target function are detected. Furthermore, the provision of the first data set may however also comprise applying other methods for collecting data, such as applying an image retrieval method. Collecting data in this way can lead to a very large amount of data, but not all of these data are generally required for a particular purpose.

In step 5, the first data set can then be filtered by means of at least one data filter or sorted on the basis of corresponding parameters, and data that show particular contents can be filtered out of the first data set. For example, in step 5, the scenarios on the basis of which the machine learning algorithm has not yet been trained can be filtered out of the first data set in order to further optimize the properties of the machine learning algorithm. For example, the data filters can each be configured to filter out, from the elements or data of the first data set, the data that comprise particular objects, in particular if the machine learning algorithm is an object or image classification algorithm.

Furthermore, filtering out data from the first data set can also comprise selecting testing data for validating or verifying the trained machine learning algorithm prior to the completion of the actual training method.

The method 1 can be repeated at any time, and the data requirements in the selection of suitable training and/or testing data may change very frequently. In this case, the selection can also comprise filtering out training data for retraining an already trained machine learning algorithm, wherein the training data can be filtered out, for example, from test results or, on the basis of empirical values, from the first data set. For example, the data may be data that, in the context of previous tests, led to an erroneous behavior or malfunction of a corresponding target function. Furthermore, the ensemble of data filters can however also learn from previous configurations and derive requirements of the machine learning algorithm therefrom.

According to the embodiments of FIG. 1, step 5 of selecting the first data set by filtering the first data set by means of at least a part of the configured data filters of the ensemble of data filters further comprises a step 6 of respectively filtering the first data set by means of at least a part of the configured data filters of the ensemble of data filters in order to obtain filtered data, wherein the filtered data are subsequently classified in a step 7 on the basis of the requirements of the machine learning algorithm in order to obtain classified data, and wherein in a step 8 data are selected from the classified data on the basis of the requirements of the machine learning algorithm, wherein the selected data form the data set for training and/or testing the machine learning algorithm.

As also shown in FIG. 1, the method further comprises a step 9 of fusing the filtered data of various data filters of the ensemble of data filters in order to obtain fused filtered data, and wherein the step 7 of classifying the filtered data on the basis of the requirements of the machine learning algorithm comprises classifying the fused filtered data on the basis of the requirements of the machine learning algorithm.

Depending on the settings of the fusion, data selection can be controlled, for example if individual properties of only individual data filters of the ensemble of data filters are classified.

For example, a data filter of the ensemble of data filters can be configured to search for pedestrians in the data of the first data set, a further data filter can be configured to search for crosswalks in the data of the first data set, and a third data filter of the ensemble of data filters can be configured to search for motor vehicles searching on a right lane, wherein the correspondingly filtered data are subsequently fused in order to sort out scenarios from the first data set in which a pedestrian walks across a crosswalk and a motor vehicle simultaneously drives on a right lane.

According to the embodiments of FIG. 1, the elements or data of the first data set are furthermore sensor data, wherein the corresponding sensor may, for example, be an optical sensor, such as a RADAR, LiDAR or ultrasonic sensor. Moreover, the first data set further comprises metadata.

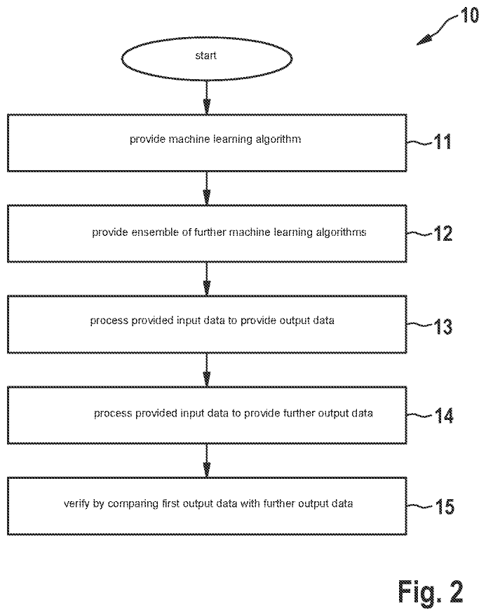

FIG. 2 is a flowchart of a method 10 for verifying a machine learning algorithm trained to solve a particular problem.

As FIG. 2 shows, the method 10 in this case comprises a step 11 of providing a machine learning algorithm trained to solve the particular problem and a step 12 of providing an ensemble of further machine learning algorithms likewise trained to solve the particular problem, wherein first output data are provided in a step 13 by processing provided input data by means of the algorithm and further output data are moreover provided in a step 14 by likewise processing the provided input data by means of at least a part of the machine learning algorithms of the ensemble of further machine learning algorithms, and wherein the machine learning algorithm is subsequently verified in a step 15 by comparing the first output data with the further output data.

A method 10 for verifying a machine learning algorithm trained to solve a particular problem is thus provided, with which the performance, correctness, robustness and/or generalization capability of a machine learning algorithm trained to solve a particular problem can be tested or verified in a simple manner and with comparatively low computing capacities on the basis of an ensemble of further machine learning algorithms. Testing the performance and/or correctness of the machine learning algorithm also has the advantage that, after corresponding verification of the performance and/or correctness, for example safety-critical situations when controlling functions of an autonomously driving motor vehicle can be avoided by the trained machine learning algorithm.

On the basis of the result of the verification of the machine learning algorithm in step 15, the latter can subsequently be found to be good and, for example, be added to a data pool or discarded. Moreover, the verification results can be used to retrain the machine learning algorithm accordingly, for example on the basis of a method described above for training a machine learning algorithm.

According to the embodiments of FIG. 2, the step 15 of verifying the algorithm comprises determining the consistency of the first output data and of the further output data.

Furthermore, step 15 can also respectively comprise determining a relationship of objects in the first output data and the further output data or respectively determining a scenario depicted in the first output data and a scenario depicted in the further output data and subsequently comparing the scenario depicted in the first output data with the scenario depicted in the further output data. In this case, relationships between objects in the output values can be respectively determined, for example on the basis of a relation between the objects, such as a size ratio, an aspect ratio, a spatial arrangement or a distance.

According to the embodiments of FIG. 2, at least one machine learning algorithm of the ensemble of further machine learning algorithms is designed to perform a different task than other machine learning algorithms of the ensemble of further machine learning algorithms. For example, one member of the ensemble of further machine learning algorithms can be designed to detect pedestrians, while another member of the ensemble of further machine learning algorithms can be trained for semantic segmentation.

According to the embodiments of FIG. 2, at least one machine learning algorithm of the ensemble of further machine learning algorithms moreover has a different architecture than other machine learning algorithms of the ensemble of further machine learning algorithms, which leads to different properties or different strengths and weaknesses of the individual members of the ensemble.

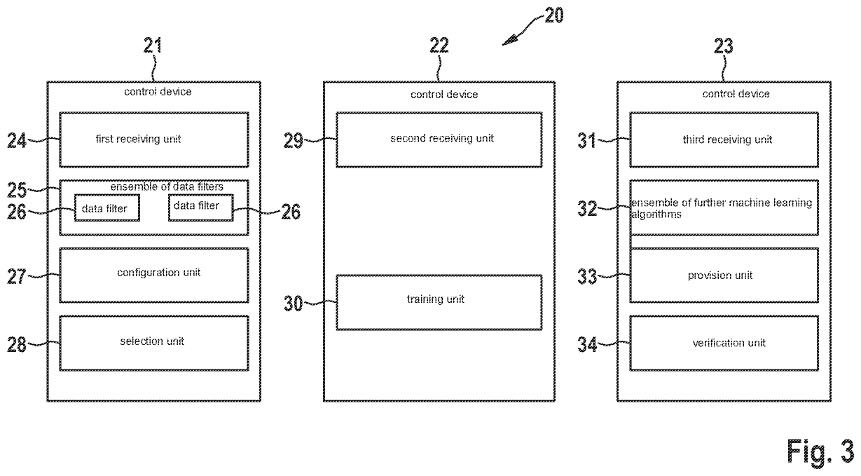

FIG. 3 is a block diagram of a system 20 for training a machine learning algorithm according to embodiments of the present invention.

As shown in FIG. 3, the system 20 comprises a control device 21 for generating a data set for training and/or testing a machine learning algorithm, a control device 22 for training a machine learning algorithm on the basis of a training data set generated by the control device 21 for generating a data set for training and/or testing a machine learning algorithm, and a control device 23 for verifying a machine learning algorithm trained by the control device 22 for training a machine learning algorithm.

The control device 21 for generating a training data set for training and/or for generating a testing data set of a machine learning algorithm in particular comprises: a first receiving unit 24 which is designed to receive a first data set, wherein the first data set comprises data potentially relevant to the machine learning algorithm; an ensemble of data filters 25, wherein the ensemble of data filters 25 has at least two data filters 26; a configuration unit 27 which is designed to set or configure each data filter 26 of the ensemble of data filters 25 independently of one another in each case on the basis of requirements of the machine learning algorithm; and a selection unit 28 which is designed to select the first data set by filtering the first data set by means of at least a part of the configured data filters of the ensemble of data filters in order to obtain data for training and/or testing the machine learning algorithm, wherein the data form the data set for training and/or testing the machine learning algorithm.

The first receiving unit may, for example, be a receiver or transceiver which is designed to receive the first data set, wherein the first data set may be sensor data, for example. The data filters may, for example, be image, data or signal filters, or even simple query filters for the metadata search. The configuration unit and the selection unit may furthermore each be implemented, for example, on the basis of a code that can be executed by a processor and is stored in a memory.

The control device 22 for training a machine learning algorithm furthermore comprises a second receiving unit 29 for receiving a data set, generated by the control device 21 for generating a data set for training and/or testing a machine learning algorithm, for training the machine learning algorithm and a training unit 30 which is designed to train a machine learning algorithm on the basis of the data set, received by the second receiving unit 29, for training the machine learning algorithm.

The second receiving unit may in turn, for example, be a receiver or transceiver which is designed to receive the generated training data. The training unit in turn may furthermore be implemented, for example, on the basis of a code that can be executed by a processor and is stored in a memory.

The control device 23 for verifying a machine learning algorithm trained by the control device 22 for training a machine learning algorithm furthermore comprises: a third receiving unit 31 for receiving a machine learning algorithm trained, by the control device 22 for training a machine learning algorithm, to solve a particular problem; an ensemble 32 of further machine learning algorithms likewise trained to solve the particular problem; a provision unit 33 which is designed to provide, by the machine learning algorithm, first output data by processing provided input data, for example stored in a memory or generated by a method described above for generating a data set for training and/or testing a machine learning algorithm, wherein the provision unit 33 is also designed to provide further output data by likewise processing the provided input data by means of at least a part of the machine learning algorithms of the ensemble of further machine learning algorithms; and a verification unit 34 which is designed to verify the machine learning algorithm by comparing the first output data with the further output data.

The third receiving unit may, for example, in turn be a receiver or transceiver which is designed to receive the trained machine learning algorithm. The provision unit and the verification unit may furthermore in turn be implemented, for example, on the basis of a code that can be executed by a processor and is stored in a memory.

What is claimed is:

1. A method for generating a data set for training and/or testing a machine learning algorithm, the method comprising the following steps:
providing a first data set, wherein the first data set includes data potentially relevant to the machine learning algorithm;
providing an ensemble of data filters;
configuring each data filter of the ensemble of data filters based on requirements of the machine learning algorithm; and
selecting the first data set by filtering the first data set using at least a part of the configured data filters of the ensemble of data filters in order to obtain data for training and/or testing the machine learning algorithm, wherein the data form the data set for training and/or testing the machine learning algorithm.

2. The method according to claim 1, wherein the step of selecting the first data set by filtering the first data set using at least a part of the configured data filters of the ensemble of data filters includes:
respectively filtering the first data set using at least a part of the configured data filters of the ensemble of data filters in order to obtain filtered data;
classifying the filtered data based on the requirements of the machine learning algorithm in order to obtain classified data; and
selecting data from the classified data based on the requirements of the machine learning algorithm, wherein the selected data form the data set for training and/or testing the machine learning algorithm.

3. The method according to claim 2, wherein the step of selecting the first data set by filtering the first data set using at least a part of the configured data filters of the ensemble of data filters further includes fusing the filtered data of various data filters of the ensemble of data filters in order to obtain fused filtered data, and wherein the step of classifying the filtered data based on the requirements of the machine learning algorithm includes classifying the fused filtered data based on the requirements of the machine learning algorithm.

4. The method according to claim 1, wherein the data potentially relevant to the machine learning algorithm are sensor data.

5. The method according to claim 1, wherein the first data set includes metadata.

6. A method for training a machine learning algorithm, comprising the following steps:
generating a data set for training the machine learning algorithm by:
providing a first data set, wherein the first data set includes data potentially relevant to the machine learning algorithm,
providing an ensemble of data filters,
configuring each data filter of the ensemble of data filters based on requirements of the machine learning algorithm, and
selecting the first data set by filtering the first data set using at least a part of the configured data filters of the ensemble of data filters in order to obtain data for training the machine learning algorithm, wherein the data form the data set for training the machine learning algorithm; and
training the machine learning algorithm based on the generated data set.

7. A method for classifying image data, comprising:
training a machine learning algorithm, the training including:
generating a data set for training the machine learning algorithm by:
providing a first data set, wherein the first data set includes data potentially relevant to the machine learning algorithm,
providing an ensemble of data filters,
configuring each data filter of the ensemble of data filters based on requirements of the machine learning algorithm, and
selecting the first data set by filtering the first data set using at least a part of the configured data filters of the ensemble of data filters in order to obtain data for training the machine learning algorithm, wherein the data form the data set for training the machine learning algorithm, and
training the machine learning algorithm based on the generated data set; and
classifying image data using the trained machine learning algorithm.

8. A method for verifying a machine learning algorithm trained to solve a particular problem, the method comprising the following steps:
providing a machine learning algorithm trained to solve the particular problem;
providing an ensemble of further machine learning algorithms trained to solve the particular problem;
providing first output data by processing provided input data using the machine learning algorithm and providing further output data by processing the provided input data using at least a part of the machine learning algorithms of the ensemble of further machine learning algorithms; and
verifying the machine learning algorithm by comparing the first output data with the further output data.

9. The method according to claim 8, wherein the step of verifying the machine learning algorithm includes determining consistency of the first output data and the further output data.

10. The method according to claim 8, wherein at least one machine learning algorithm of the ensemble of further machine learning algorithms is configured to perform a different task than other machine learning algorithms of the ensemble of further machine learning algorithms.

11. The method according to claim 8, wherein at least one machine learning algorithm of the ensemble of further machine learning algorithms has a different architecture than other machine learning algorithms of the ensemble of further machine learning algorithms.

12. A control device configured to generate a data set for training and/or testing a machine learning algorithm, the control device configured to:
provide a first data set, wherein the first data set includes data potentially relevant to the machine learning algorithm;
provide an ensemble of data filters;
configure each data filter of the ensemble of data filters based on requirements of the machine learning algorithm; and
select the first data set by filtering the first data set using at least a part of the configured data filters of the ensemble of data filters in order to obtain data for training and/or testing the machine learning algorithm, wherein the data form the data set for training and/or testing the machine learning algorithm.

13. A control device configured to train a machine learning algorithm, the control device configured to:
generate a data set for training the machine learning algorithm by:
providing a first data set, wherein the first data set includes data potentially relevant to the machine learning algorithm,
providing an ensemble of data filters,
configuring each data filter of the ensemble of data filters based on requirements of the machine learning algorithm, and
selecting the first data set by filtering the first data set using at least a part of the configured data filters of the ensemble of data filters in order to obtain data for training the machine learning algorithm, wherein the data form the data set for training the machine learning algorithm; and
train the machine learning algorithm based on the generated data set.

14. A control device configured to classify image data, the control device configured to:
provide a trained machine learning algorithm, the machine learning algorithm being trained by a control device configured to train the machine learning algorithm, the control device configured to train the machine learning algorithm being configured to:
generate a data set for training the machine learning algorithm by:
providing a first data set, wherein the first data set includes data potentially relevant to the machine learning algorithm,
providing an ensemble of data filters,
configuring each data filter of the ensemble of data filters based on requirements of the machine learning algorithm, and
selecting the first data set by filtering the first data set using at least a part of the configured data filters of the ensemble of data filters in order to obtain data for training the machine learning algorithm, wherein the data form the data set for training the machine learning algorithm; and
train the machine learning algorithm based on the generated data set;
classify the image data using the trained machine learning algorithm.

15. A control device configured to verify a machine learning algorithm trained to solve a particular problem, the control device configured to:
provide a machine learning algorithm trained to solve the particular problem;
provide an ensemble of further machine learning algorithms trained to solve the particular problem;
provide first output data by processing provided input data using the machine learning algorithm and providing further output data by processing the provided input data using at least a part of the machine learning algorithms of the ensemble of further machine learning algorithms; and
verify the machine learning algorithm by comparing the first output data with the further output data.
